(19) United States
(12) Patent Application Publication
(10) Pub. No.: US 2024/0163170 A1
(43) Pub. Date: May 16, 2024

(54) PROVIDING CONFIGURATION INFORMATION FOR TARGET CELLS

(71) Applicant: Nokia Technologies Oy, Espoo (FI)

(72) Inventors: Ayaz AHMED, Bangalore (IN); Ahmad AWADA, Munich (DE); Srinivasan SELVAGANAPATHY, Bangalore (IN); Jedrzej STANCZAK, Wroclaw (PL); Sankaran BALASUBRAMANIAM, Bangalore (IN)

(21) Appl. No.: 18/508,814

(22) Filed: Nov. 14, 2023

(30) Foreign Application Priority Data
Nov. 16, 2022 (IN) 202241065584

(51) Int. Cl. H04L 41/0869; H04L 41/0823; H04L 41/0853

(52) U.S. Cl. CPC H04L 41/0869; H04L 41/0823; H04L 41/0853

(57) ABSTRACT

Where a UE moves between primary and/or secondary cells, the repeated reconfiguration of a UE at the network requires repeated signalling. Where non terrestrial networks nodes provide cells it may be possible to predict which cells a UE is likely to visit and when, based on the satellite movement. Embodiments make use of this ability to predict multiple future cells by transferring configuration information for a series of target cells in a single message, in some cases along with condition information indicating when the cell is likely to be providing radio coverage for that UE. Furthermore, to reduce signalling overhead some of the information is provided as a delta information, that is as an indication of how a previous configuration will change to provide the new configuration. A UE can apply the configuration information as the conditions become fulfilled.

### TECHNOLOGICAL FIELD

Various example embodiments relate to providing configuration information for target cells as one or more of a node or user equipment move within a communication network.

### BACKGROUND

In non-terrestrial network NTN nodes, such as those provided by a LEO low earth orbit satellite, the one or more cells provided by these NTN nodes move as the satellite moves. A user equipment that is stationary or moving may connect to NTN nodes and also to terrestrial network TN nodes. A NTN node may provide a larger cell and in some cases high throughput, however there may be latency associated with a cell provided by such a node and a TN node where available may be preferred. In some cases dual connectivity may be used to provide the advantages of both an NTN node and a TN node.

When changing or adding a cell due to movement of the NTN node and/or the UE, service interruption and/or increased latency may occur while setting up the context/configuration for the new cell.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments of the invention there is provided an apparatus for accessing a radio access network, said radio access network comprising a plurality of network nodes each supporting providing radio coverage via at least one cell, said apparatus comprising: at least one processor; and at least one memory storing instructions that, when executed by the at least one processor, cause the apparatus at least to: respond to receipt of a message received from a serving network node, said message comprising information indicative of a plurality of configurations for a plurality of target cells and said request indicating an order in which said user equipment is predicted to access said target cells, said information comprising information indicative of at least one full configuration for a first cell in said predicted order and at least one delta configuration indicating a change in configuration compared to a configuration for a previous cell by: storing said information.

It was recognised that if the movement of at least one of a user equipment or network node could be predicted, then a node might be aware of not just one target cell, but of a string of subsequent target cells. Embodiments take advantage of this by providing configuration information for multiple conditional target cells in a single message sent to the UE. Furthermore, as the information for several cells is provided together, at least some of the information may be provided as delta information indicative of a change in configuration between cells, rather than sending a full configuration for each of the cells. This allows reduced signalling and potentially reduced latency and a reduction in potential service interruptions as the user equipment has the available information ready to apply when it determines it may be required.

In some example embodiments, said information further comprises a plurality of conditions corresponding to said plurality of target cells; said apparatus being further configured to determine when one of said plurality of conditions becomes fulfilled for said apparatus.

In some example embodiments, said apparatus is configured on determining said one of said plurality of conditions is fulfilled, to apply a corresponding one of said configurations.

In some example embodiments, said information further comprises a plurality of conditions corresponding to said plurality of target cells; said apparatus being further configured to determine when one of said plurality of conditions becomes fulfilled for said apparatus.

In some example embodiments, said apparatus is configured on determining said one of said plurality of conditions is fulfilled, to apply a corresponding one of said configurations.

In some example embodiments, said message further comprises validity information related to at least one of the plurality of configurations, said apparatus being configured to verify using said validity information, when one of said plurality of conditions becomes fulfilled for said apparatus, whether a corresponding target cell corresponds to a cell that said apparatus is seeking to access and where not, to not apply said corresponding configuration.

In some example embodiments, prior to applying said corresponding one of said configurations, said apparatus is configured in certain circumstances to perform measurements to determine whether to connect to said corresponding target cell.

In certain circumstances said apparatus may perform measurements to determine whether to connect to said corresponding target cells on determining said condition is fulfilled, while in other circumstances said apparatus may simply initiate said connection process and apply said configuration in response to determining said condition is fulfilled. The circumstances that affect this might be network/UE implementation or network configuration aspects.

In some example embodiments, one of said plurality of conditions becomes fulfilled when it is predicted that the apparatus is within the radio coverage of the corresponding cell.

In some example embodiments, said one of said plurality of conditions comprises a validity time, said validity time being a time when it is predicted that said apparatus is within the radio coverage of the corresponding cell.

In some example embodiments, said configuration for subsequent cells each comprise a delta configuration indicating a change in configuration compared to a configuration for a previous cell in said predicted order.

In some example embodiments, said apparatus is configured in response to missing at least one target cell of said plurality of target cells in said predicted order by not accessing said at least one target cell, to construct an updated delta configuration for a cell subsequent to said at least one missed cell using a delta configuration of said at least one missed target cell, said updated delta configuration indicating a change in configuration compared to a most recently accessed cell.

In some example embodiments, said apparatus is configured in response to missing at least one target cell of said plurality of target cells in said predicted order by not accessing said at least one target cell, said apparatus is configured to request that said radio access network reconfigures said apparatus.

In some example embodiments, said apparatus is configured for dual connectivity and said plurality of target cells comprise secondary cells provided by at least one non-terrestrial network NTN node.

In some example embodiments, said at least one NTN node comprises at least two NTN nodes. That is the plurality of target cells are provided by more than one NTN node.

In some example embodiments, said serving network node comprises a terrestrial network TN node and comprises a master node providing a primary serving cell.

In some example embodiments, said serving network node comprises a NTN node and comprises a master node providing a primary serving cell.

In some example embodiments, said apparatus is configured for single connectivity and said plurality of target cells are provided by at least one of the following: at least one TN node, at least one NTN node.

In some example embodiments, said apparatus comprises a UE.

In some example embodiments, said message comprises a RRC Reconfiguration message.

According to various, but not necessarily all, example embodiments of the invention there is provided according to an aspect an apparatus for supporting providing radio coverage via a plurality of cells, said apparatus comprising: at least one processor; and at least one memory storing instructions that, when executed by the at least one processor, cause the apparatus at least to: respond to receipt of a request for providing access for a user equipment to at least some of said plurality of cells, said at least some of said plurality of cells comprising target cells for said user equipment and said request indicating an order in which said user equipment is predicted to access said target cells by: generating a message comprising information indicative of a plurality of configurations for said target cells, said information comprising information indicative of at least one delta configuration indicating a change in configuration of one cell compared to a configuration for a previous cell.

In some example embodiments, said information indicative of configuration for said plurality of cells comprises a full configuration for a first target cell being visited and a delta configuration for subsequent target cells, said delta configuration comprising a change in configuration compared to a previous cell in said order.

In some example embodiments, said request comprises a full configuration for an initial target cell, and said information indicative of configuration for said plurality of cells comprises a plurality of delta configurations for a plurality of subsequent target cells, said delta configurations comprising a change in configuration compared to a previous cell in said order, a first delta configuration comprising a change in configuration compared to said initial target cell.

In some example embodiments, said apparatus comprises a NTN node.

In some example embodiments, said apparatus is configured to generate said message in response to receipt of one of the following: a secondary node addition request, or a conditional handover request.

In some example embodiments, said request comprises a secondary node addition request and said information indicative of configuration for said plurality of cells comprises a plurality of delta configurations for a plurality of target cells, said delta configuration comprising a change in configuration compared to a previous cell in said order, a first delta configuration comprising a change in configuration compared to a secondary cell provided by a previous secondary node.

According to various, but not necessarily all, example embodiments of the invention there is provided according to a further aspect, an apparatus for supporting providing radio coverage via at least one cell, said apparatus comprising: at least one processor; and at least one memory storing instructions that, when executed by the at least one processor, cause the apparatus at least to: generate a message for transmission to a user equipment connected to said at least one cell, said message comprising information indicative of a plurality of configurations for a plurality of target cells for said user equipment and an order in which said user equipment is predicted to access said target cells, said information comprising information indicative of a full configuration for a first cell in said predicted order and at least one delta configuration indicating a change in configuration compared to a configuration for a previous cell in said order.

In some example embodiments, said information further comprises a plurality of conditions corresponding to said plurality of target cells and configurations.

In some example embodiments, said apparatus is configured to generate said message in response to receipt of an indication of said plurality of configurations from a network node providing radio resources in said plurality of target cells.

In some example embodiments, said apparatus is configured to generate a request for transmission to a network node providing radio resources in said plurality of target cells for conditional connection of said user equipment to said plurality of target cells, said request comprising an indication of said plurality of target cells and an order in which said user equipment is predicted to access said target cells.

In some example embodiments, said apparatus is configured to generate said request as one of a conditional handover request or secondary node addition request.

In some example embodiments, said request comprises said conditional handover request and said apparatus comprises an NTN network node, said apparatus being configured to provide satellite assistance information with said conditional handover request.

In some example embodiments, said network node providing said radio coverage in said plurality of target cells comprises an NTN node and said apparatus is responsive to receipt of a message comprising satellite assistance information relating to at least one satellite providing said NTN node to determine said order in which said user equipment is predicted to access said target cells.

In some example embodiments, said satellite assistance information is indicative of at least one of the following: location, direction, speed of a satellite, NTN satellite beam switching time, or ephemeris.

In some example embodiments, said apparatus is configured in response to receipt of a request that said radio access network reconfigures said user equipment for one of said plurality of target cells, to generate a configuration for said one of said plurality of target cells and at least one delta configuration for at least one target cell subsequent to said one of said plurality of target cells in said predicted order.

According to various, but not necessarily all, example embodiments of the invention there is provided a communication network comprising at least one apparatus for supporting providing radio coverage via a plurality of cells according to an aspect, and an apparatus for supporting providing radio coverage via at least one cell according to a further aspect.

According to various, but not necessarily all, example embodiments of the invention there is provided a method for accessing a radio access network, said radio access network comprising a plurality of network nodes each supporting providing radio coverage via at least one cell, said method comprising: receiving a message from a serving network node, said message comprising information indicative of a plurality of configurations for a plurality of target cells, and said message indicating an order in which said user equipment is predicted to access said target cells, said information comprising information indicative of at least one full configuration for a first cell in said predicted order and at least one delta configuration indicating a change in configuration compared to a configuration for a previous cell; and storing said information.

In some example embodiments, said information further comprises a plurality of conditions corresponding to said plurality of target cells; said method further comprising determining when one of said plurality of conditions becomes fulfilled.

In some example embodiments, said method comprises on determining said one of said plurality of conditions is fulfilled, applying a corresponding one of said configurations.

In some example embodiments, said message further comprises validity information related to at least one of the plurality of configurations, said method further comprising verifying using said validity information, when one of said plurality of conditions becomes fulfilled for said apparatus whether a corresponding target cell corresponds to a cell that said apparatus is seeking to access and where not, said method comprises not applying said corresponding configuration.

In some example embodiments, prior to applying said corresponding one of said configurations, said method comprises performing measurements to determine whether to connect to said corresponding target cell.

In some example embodiments, said method comprises, in response to missing at least one target cell of said plurality of target cells in said predicted order by not accessing said at least one target cell, constructing an updated delta configuration for a cell subsequent to said at least one missed cell using a delta configuration of said at least one missed target cell, said updated delta configuration indicating a change in configuration compared to a most recently accessed cell.

In some example embodiments, said method comprises, in response to missing at least one target cell of said plurality of target cells in said predicted order by not accessing said at least one target cell, requesting a reconfiguration from said radio access network.

In some example embodiments, said method if performed by a UE.

According to various, but not necessarily all, example embodiments of the invention there is provided a method for supporting providing radio coverage via a plurality of cells, said method comprising:
receiving a request for providing access for a user equipment to at least some of said plurality of cells, said at least some of said plurality of cells comprising target cells for said user equipment; and
generating a message comprising information indicative of a plurality of configurations for said target cells, said information comprising information indicative of at least one delta configuration indicating a change in configuration of one cell compared to a configuration for a previous cell.

In some example embodiments, said method comprises generating said message in response to receipt of one of the following: a conditional handover request, a secondary node addition request or a conditional handover request.

According to various, but not necessarily all, example embodiments of the invention there is provided a method for supporting providing radio coverage via at least one cell, said method comprising: generating a message for transmission to a user equipment connected to said at least one cell, said message comprising information indicative of a plurality of configurations for a plurality of target cells for said user equipment and an order in which said user equipment is predicted to access said target cells, said information comprising information indicative of a full configuration for a first cell in said predicted order and at least one delta configuration indicating a change in configuration compared to a configuration for a previous cell in said order.

In some example embodiments, said information further comprises a plurality of conditions corresponding to said plurality of target cells and configurations

In some example embodiments, said method comprises receiving an indication of said plurality of configurations from a network node providing radio coverage in said plurality of target cells and, in response to receipt of said indication, generating said message.

In some example embodiments, said method comprises generating a request for transmission to a network node providing radio resource in said plurality of target cells, for conditional connection of said user equipment to said plurality of target cells, said request comprising an indication of said plurality of target cells and an order in which said user equipment is predicted to access said target cells.

In some example embodiments, said method comprises generating said request as one of the following: a conditional handover request or a secondary node addition request.

In some example embodiments, said network node providing said radio coverage in said plurality of target cells comprises an NTN node and said method comprises, in response to receipt of a message comprising satellite assistance information relating to at least one satellite providing said NTN node, determining said order in which said user equipment is predicted to access said target cells.

In some example embodiments, said method comprises in response to receipt of a request that said radio access network reconfigures said user equipment for one of said plurality of target cells, to generating a configuration for said one of said plurality of target cells and at least one delta configuration for at least one target cell subsequent to said one of said plurality of target cells in said predicted order.

According to various, but not necessarily all, example embodiments of the invention there is provided a non-transitory computer readable medium comprising program instructions stored thereon for performing at least the following: respond to receipt of a message received from a serving network node, said message comprising information indicative of a plurality of configurations for a plurality of target cells and said request indicating an order in which said user equipment is predicted to access said target cells, said information comprising information indicative of at least one full configuration for a first cell in said predicted order and at least one delta configuration indicating a change in configuration compared to a configuration for a previous cell, by: storing said information.

According to various, but not necessarily all, example embodiments of the invention there is provided a non-transitory computer readable medium comprising program instructions stored thereon for performing at least the following: respond to receipt of a request for providing access for a user equipment to at least some of said plurality of cells, said at least some of said plurality of cells comprising target cells for said user equipment and said request indicating an order in which said user equipment is predicted to access said target cells by: generating a message comprising information indicative of a plurality of configurations for said target cells, said information comprising information indicative of at least one delta configuration indicating a change in configuration of one cell compared to a configuration for a previous cell in said predicted order.

According to various, but not necessarily all, example embodiments of the invention there is provided a non-transitory computer readable medium comprising program instructions stored thereon for performing at least the following: generate a message for transmission to a user equipment connected to said at least one cell, said message comprising information indicative of a plurality of configurations for a plurality of target cells for said user equipment and an order in which said user equipment is predicted to access said target cells, said information comprising information indicative of a full configuration for a first cell in said predicted order and at least one delta configuration indicating a change in configuration compared to a configuration for a previous cell in said order.

According to various, but not necessarily all, example embodiments of the invention there is provided an apparatus for accessing a radio access network, said radio access network comprising a plurality of network nodes each supporting providing radio coverage via at least one cell, said apparatus comprising: means for storing data; and means for controlling said apparatus, said means for controlling being configured to respond to receipt of a message received from a serving network node, said message comprising information indicative of a plurality of configurations for a plurality of target cells and said request indicating an order in which said user equipment is predicted to access said target cells, said information comprising information indicative of at least one full configuration for a first cell in said predicted order and at least one delta configuration indicating a change in configuration compared to a configuration for a previous cell, by controlling said means for storing to store said information.

In some example embodiments, said information further comprises a plurality of conditions corresponding to said plurality of target cells; said apparatus further comprising: means for determining when one of said plurality of conditions becomes fulfilled for said apparatus.

In some example embodiments, said apparatus comprises means for applying a corresponding one of said configurations in response to said means for determining said one of said plurality of conditions is fulfilled.

In some example embodiments, said message further comprises validity information related to at least one of the plurality of configurations, said apparatus comprising means for verifying, using said validity information, when one of said plurality of conditions becomes fulfilled for said apparatus whether a corresponding target cell corresponds to a cell that said apparatus is seeking to access and where not, said means for applying is configured to not apply said corresponding configuration.

In some example embodiments, said apparatus comprises means for performing measurements to determine whether to connect to a corresponding target cell, said means for performing being configured to perform said measurements prior to said means for applying applying said corresponding one of said configurations,

In some example embodiments, said apparatus comprises means for generating a delta configuration, said means for generating being configured in response to said means for verifying indicating at least one target cell of said plurality of target cells in said predicted order has been missed, to construct an updated delta configuration for a cell subsequent to said at least one missed cell using a delta configuration of said at least one missed target cell, said updated delta configuration indicating a change in configuration compared to a most recently accessed cell.

In some example embodiments, said apparatus comprises means for requesting, said means for requesting being configured in response to missing at least one target cell of said plurality of target cells in said predicted order by not accessing said at least one target cell, to generate a request for transmission to said radio access network requesting said radio access network reconfigures said apparatus.

According to various, but not necessarily all, example embodiments of the invention there is provided an apparatus for supporting providing radio coverage via a plurality of cells, said apparatus comprising: means for controlling said apparatus said means for controlling being responsive to receipt of a request for providing access for a user equipment to at least some of said plurality of cells, said at least some of said plurality of cells comprising target cells for said user equipment and said request indicating an order in which said user equipment is predicted to access said target cells by controlling a means for generating to generate a message comprising information indicative of a plurality of configurations for said target cells, said information comprising information indicative of at least one delta configuration indicating a change in configuration of one cell compared to a configuration for a previous cell in said predicted order.

According to various, but not necessarily all, example embodiments of the invention there is provided an apparatus for supporting providing radio coverage via at least one cell, said apparatus comprising: means for generating a message for transmission to a user equipment connected to said at least one cell, said message comprising information indicative of a plurality of configurations for a plurality of target cells for said user equipment and an order in which said user equipment is predicted to access said target cells, said information comprising information indicative of a full configuration for a first cell in said predicted order and at least one delta configuration indicating a change in configuration compared to a configuration for a previous cell in said order.

In some example embodiments, said means for generating is configured to generate said message in response to receipt of an indication of said plurality of configurations from a network node providing radio resources in said plurality of target cells.

In some example embodiments, said apparatus is means for generating is configured to generate a request for transmission to a network node providing radio resources in said plurality of target cells for conditional connection of said user equipment to said plurality of target cells, said request comprising an indication of said plurality of target cells and an order in which said user equipment is predicted to access said target cells.

In some example embodiments, said means for generating is configured in response to receipt of a request that said radio access network reconfigures said user equipment for one of said plurality of target cells, to generate a configuration for said one of said plurality of target cells and at least one delta configuration for at least one target cell subsequent to said one of said plurality of target cells in said predicted order.

In some example embodiments, said means for controlling comprises a controller or circuitry configured to control; said means for determining comprises circuitry configured to determine; said means for applying comprises circuitry configure to apply, said means for verifying comprises circuitry configure to verify; said means for generating comprises circuitry configured to generate; means for performing measurements comprises circuitry configured to perform measurements; said means for requesting comprises circuitry configured to request; said means for storing comprises a data store, memory or cache, or circuitry configured to store.

In some example embodiments said apparatus further comprises means for transmitting and receiving. In some example embodiments, said means for transmitting comprises a transmitter or circuitry configured to transmit. In some example embodiments said means for receiving comprises a receiver or circuitry configured to receive.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

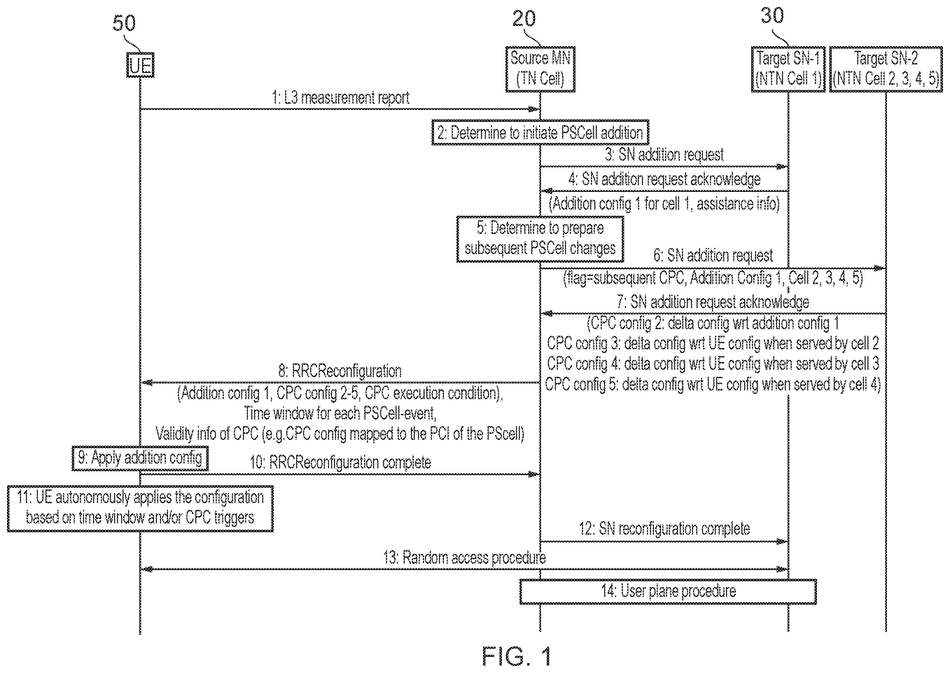

FIG. 1 illustrates signalling in a network according to an example embodiment of the subject matter described herein;

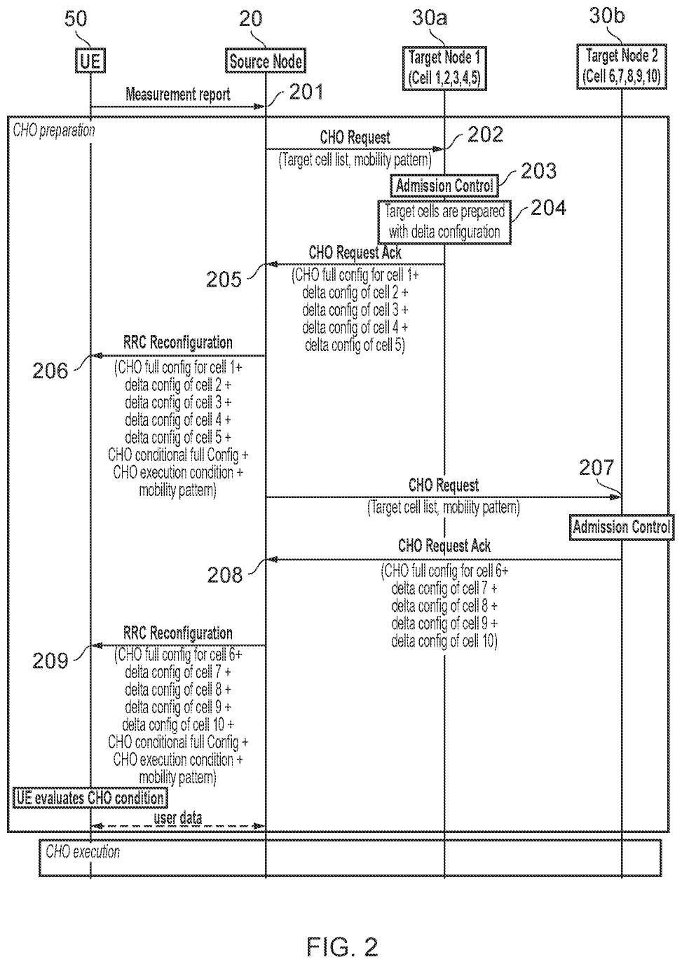

FIG. 2 illustrates signalling in a network according to a different example embodiment of the subject matter described herein;

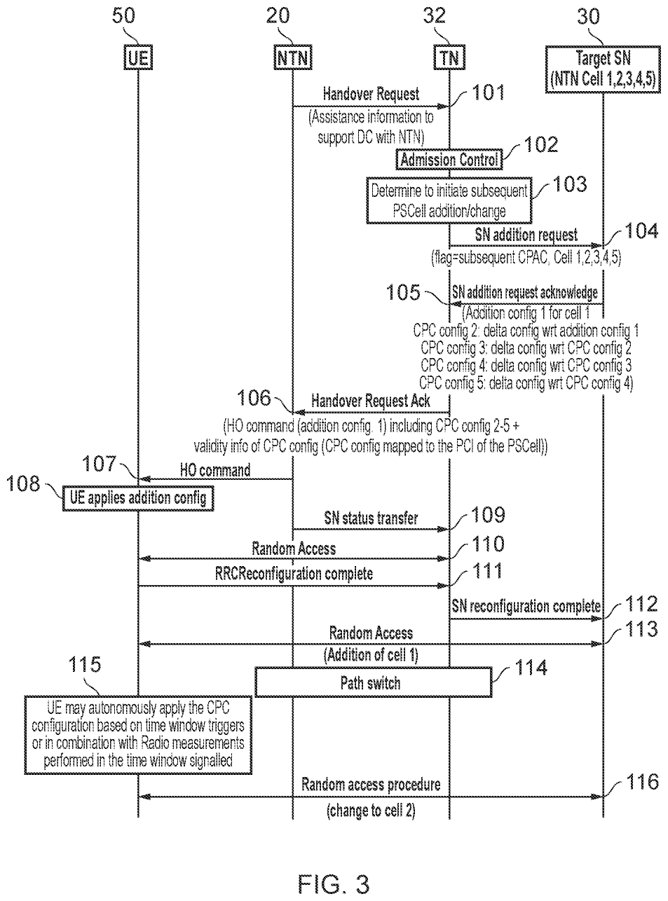

FIG. 3 illustrates signalling in a network according to a further example embodiment of the subject matter described herein;

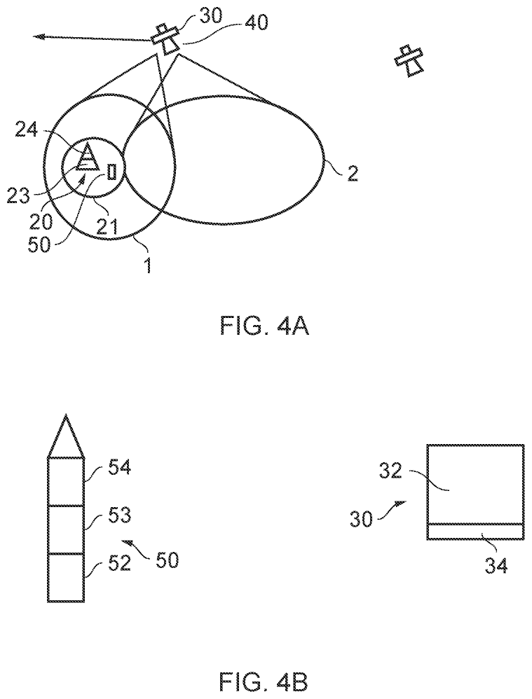

FIGS. 4A and 4B illustrate apparatus within a network according to an example embodiment.

### DETAILED DESCRIPTION

Before discussing the example embodiments in any more detail, first an overview will be provided.

Where a UE moves between primary and/or secondary cells, the repeated reconfiguration of a UE at the network requires repeated signalling. In some cases it may be possible to predict which cells a UE is likely to visit and when. Where the cells are NTN cells then this prediction may be based on the satellite movement. Embodiments make use of this ability to predict multiple future cells by transferring configuration information for a series of target cells in a single message. Furthermore, to reduce signalling overhead some of the information is provided as a delta information, that is as an indication of how a previous configuration will change to provide the new configuration. This allows less information to be sent and indeed less data to be stored at the UE. In some cases the information may be a list, with a full configuration for the first target cell, and delta information for each subsequent cell, the delta being a change with respect to the immediately preceding cell. The order of the list indicating the order that the cells are predicted to be visited in.

Where the UE is configured for dual connectivity and the cell list relates to multiple cells provided by a secondary node, then the transfer of this configuration information is also made between the secondary node and the serving master node and in some cases between a secondary node and the master and a further target secondary node.

A condition may be transmitted with the configuration information the condition becoming fulfilled indicating when the user equipment is predicted to move into the radio coverage area of that cell. This condition may be a time, and this may enable the UE to only perform monitoring to determine if a handover should be performed and the stored configuration related to that cell applied when it is likely to be within the target cell.

Embodiments consider NTN-TN and NTN-NTN mobility involving dual connectivity (DC) between NTN-TN and NTN-NTN, in some of the overlapping NTN and TN coverage scenario; in order to support high throughput requirements. Embodiments also consider single connectivity conditional handovers both from NTN to NTN, TN to NTN and NTN to TN.

Example embodiments and the principles outlined in this disclosure are applicable for both NTN-TN or TN-NTN dual connectivity and for NTN CHO.

A NTN cell may provide wider coverage compared to a TN cell. The size of the cell depends on the type of NTN node, a GEO geo-stationary orbit satellite hosting the NTN node or a LEO low earth orbit satellite hosting it. NTN GEO satellite cell coverage is large but does introduce higher E2E (end to end) latency, which is a major constraint to serve high throughput users. Although NTN LEO coverage is expected to support higher throughput, there might be potential service interruptions resulting from the HOs handovers triggered due to satellite movement or to feeder link switch. Given this, when overlapping TN coverage is available, configuring dual connectivity between NTN and TN enables the support of high throughput services and mitigates the above listed constraints of NTN system.

In embodiments, the focus is on NTN coverage provided by LEO with overlapping TN coverage (the overlapping coverage may be continuous or discontinuous). UE may perform initial access either to the NTN or to the TN.

FIG. 1 shows a signalling diagram between an apparatus in the form of a UE 50 which is served by a TN cell 20, sometimes referred to as a source node, master node, or serving node. The serving node may be a TN or NTN node. If the source node (TN node) 20, decides to configure dual connectivity with a LEO NTN cell 30 as PSCell then owing to LEO satellite movement, the PSCell that is able to serve the UE changes. Given that the PSCell changes due to satellite movement, the source node needs to (re)configure the UE periodically based on the PSCell switching time (due to satellite movement), which results in quite a lot of extra signalling. Furthermore, the PSCell may belong to the same Secondary Node (SN) or a different SN.

Embodiments provide NTN specific new enhancements to enable Conditional PSCell Change (CPC) in this scenario efficiently.

The signalling performed in this scenario is outlined below, the number of the signal being the number shown in FIG. 1.

1. UE 50 transmits L3 measurements configured to detect NTN cell coverage.

2. Based on the L3 UE measurements, the source node (TN node 20) determines that the PSCell addition procedure should be initiated.

3. Source node 20 transmits a secondary node (SN) Addition Request to a first target secondary node 30 (target SN NTN node).

4. In response to the SN Addition procedure, the target SN 30 responds and includes satellite related assistance information and associated configuration for PSCell addition in this response.

5. The assistance information is used by the source node 20 (TN node) to prepare subsequent PSCell changes.
Assistance information might be for example an NTN cell or NTN satellite beam switching time etc. The assistance information may include ephemeris information relating to the LEO satellite providing the NTN node. The assistance information may include location, direction, speed of the satellite.
Using the assistance information, the source node (TN node) prepares the target SN(s)(NTN node(s)) for subsequent PSCell changes. As part of this step, the source node initiates a SN Addition Request to a further target SN node.

6. This SN addition request that may include a flag indicating ‘subsequent CPC conditional PSCell change’ and a target cell list. along with the Initial PSCell Addition configuration to be used as a base configuration by the target SN (NTN target node) to prepare delta configurations for subsequent PSCell changes. A delta configuration indicates a change in configuration compared to a configuration for a previous cell (where the previous cell is a first cell and provides a full configuration, which may be referred to as a base configuration). In this way, information that is unchanged in both the base configuration and the delta configuration of the next cell to be accessed need not be repeated in the signalling. As a result, using a delta configuration reduces the amount of information transmitted compared to a full configuration.

7. The target node 30 prepares the Conditional PSCell Change (CPC) configurations for subsequent PSCell changes using the CPC configuration of previous PSCell as the base.

i. i.e. the first PSCell change (or simply first CPC) configuration shall be the delta configuration with initial PSCell Addition (CPA conditional PSCell addition) full configuration as the base.

ii. And subsequent CPC configurations shall be the delta configuration of the previous CPC configuration.
These delta configurations are transmitted to the source node 20 in a SN additional request acknowledge signal. By sending all the configurations at the same time, the need for multiple messages is avoided and the signalling traffic is reduced.

FIG. 1 shows that the initial secondary cell (NTN cell 1) is provided by Target node SN-1 and that subsequent secondary cells (NTN Cell 2, 3, 4, 5) are provided by target node SN-2. However, it will be appreciated that the plurality of target cells may all be provided by a single target node, for example, a LEO satellite may provide multiple cells formed by different beams. Alternatively, more than two target nodes may provide the plurality of target cells.

8. The source node 20 reconfigures the UE 50 with the Conditional PSCell Addition (CPA) configuration (which is the full base configuration) and CPC configurations for the subsequent PSCell changes (which are the delta configurations) together with CPC execution condition for each PSCell event. The CPC configuration are delta configurations which can be applied by the UE 50 consecutively after each PSCell change without creating any reconfiguration failure (the configuration of the new PSCell is a delta configuration with respect the previous serving PSCell configuration). This is transmitted to the UE 50 as a RRC reconfiguration signal. The CPC execution condition for each PSCell event is the condition which when fulfilled indicates that the UE is predicted to be within the corresponding cell. It may be a time (sometimes referred to as a validity time).

In addition to this, the CPC execution condition may include validity info of the CPC configuration. For example, if a mobile UE moves in a direction opposite to the satellite movement, then the UE may well break the order of PSCell change predicted due to satellite movement. The conditions provided with the configuration information relate to a predicted order that the UE will visit the cells, thus, if the order of the cells changes, the UE may assume from the conditions (which may be a time) that it is in a certain cell when it is not and it could then apply an incorrect CPC configuration. In order to handle this, the CPC execution condition may include validity info e.g. CPC configuration may be mapped to the PCI (physical cell identity) of the PSCell. In effect, the UE 50 uses validity information to check and verify that a cell that the UE 50 is seeking to access is in fact the predicted target cell. If there is not a match, the UE 50 does not apply the provided configuration information as it relates to a different cell. The situation in which the UE 50 misses or fails to connect to one or more of the predicted target cells is discussed in more detail below.

9. The UE 50 applies the addition full configuration based on the PSCell it is accessing.

10. The UE 50 transmits a RRC reconfiguration complete message to signal to the source node 20 when it successfully applies the configuration.

11. The UE may autonomously apply the received configuration based on the predicted configuration information of the PSCell or NTN satellite beam switch (e.g. time window) or any other configured CPC triggers. In other embodiments, the UE 50 may perform measurements to determine whether to connect to a target cell and it may perform the measurements only at the time that the condition is fulfilled. For example, the UE 50 may perform radio measurements within the time window indicates that a target cell is available. When performing such measurements the UE may also check that the cell is the expected cell using the validity information as discussed above.

12. The source node 20 messages the target secondary node 30 that UE reconfiguration is complete.

13. Random access procedure occurs between the UE 50 and target secondary node 30.

14. User plane procedures occur.

In case the UE 50 breaks the order of PSCell changes or fails to connect to a target cell, then it may

i. either construct a configuration for a new target cell which is predicted to be available at the present time with reference to the last applied configuration and the delta configuration of the skipped PSCells, or

ii. simply indicate to the network of the skip in the order of PSCell change; thus allowing the network to reconfigure the UE. In some cases, the UE 50 indicates the skip to the master node 20 and the master node 20 reconfigures the UE 50.

FIG. 2 shows an extension of the scenario shown in FIG. 1 for single connectivity TN or NTN CHO. The numbers below represent the numbers relating to the different signals and steps performed in the FIG. 2

201. UE 50 transmits L3 measurements configured to detect cell coverage.

202. Source gNB 20, sometimes referred to as source node or serving node, indicates the list of target cells to be prepared for consecutive conditional handovers CHO and the predefined pattern of mobility to Target gNB 30a.

203. Target node gNB 30a performs admission control.

204. Target gNB 30a prepares the configurations for multiple target cells (cell 1, 2, 3, 4, 5) based on the delta configuration of each previous cell and includes the same in CHO Request Ack message (205).
In the case that the list contains target cells that belong to different gNBs, the source gNB completes the HO preparation in sequence based on the last prepared target cell as reference for preparation of the next one.

206. RRC reconfiguration message is sent to the UE and includes a full configuration for the first cell and multiple delta configurations along with a ‘mobility pattern’ which indicates where the given configurations are predicted to be applicable. This new parameter indicates the expected sequence of CHO execution applicable for given configuration.
Source Node may provide additional conditional configuration for target cell which does not depend on the pattern, if required based on UE measurement report. This new configuration is maintained as an additional entry in the conditional configuration list. When CHO condition is met for the target cell, based on whether it matches the pattern or not, UE may select configuration prepared for successive CHO or the normal CHO configuration.

Steps 207, 208 and 209 are similar to steps 202-206 except that they relate to target node 2 (30b in FIG. 2) which provides additional target cells 6, 7, 8, 9 and 10. After step 209, the UE 50 evaluates the CHO condition and the handover is executed.

It will be appreciated that source node 20, target node 1 (30a), and target node 2 (30b) may be either a TN or an NTN.

FIG. 3 shows a different scenario in which the UE 50 is served by a NTN cell/node 20. On detection of TN coverage, UE 50 may be handed over to TN cell/node 32 and the TN node may configure the dual connectivity (DC) during overlapping coverage based on throughput requirements. In this scenario for the TN 32 to configure DC and subsequent Conditional PSCell Change (CPC) with NTN LEO (that has a predictable cell or beam switching time due to LEO satellite movement), to prepare the Conditional PSCell change (CPC) configuration based on predictability info, some new NTN specific enhancements are required to make the CPC preparation and execution efficient.

For the scenario shown in FIG. 3 (UE served by NTN): a UE may be handed over to TN cell upon detection of TN coverage.

On detection of TN coverage, a UE 50 served by the NTN cell 20 may be configured to trigger HO to the TN cell 32 based on L3 measurements.

101. Given the NTN node 20 is triggering the HO to the TN cell 32, the NTN node may include assistance information (e.g. NTN cell or satellite beam switching time from ephemeris) in the HO request to enable the TN node 32 to configure dual connectivity (DC) with NTN 30 as secondary node (SN).

102. Target node 32 performs admission control.

103. The target node (TN node) 32, based on the assistance information in HO Request (101) and the UE 50 L3 measurements, may decide to configure conditional PSCell Addition (CPA) by preparing target node (NTN node) 30.

104. In the SN addition procedure the target node (TN node) may include assistance information e.g. a flag—‘subsequent CPC’ to indicate to the target SN (NTN node) 30 to prepare subsequent CPC configuration for the consecutive PSCells supported by the target SN.

Similar to the procedure shown in FIG. 1, the target SN 30 prepares the consecutive CPC configuration with initial CPA configuration as full base configuration and the subsequent CPC configuration (for consecutive PSCell changes) as the delta configuration to the previous PSCell configuration.
The initial PSCell addition shall be a full base configuration, upon which the CPC configuration for the subsequent PSCells is prepared as delta of the previous PSCell configuration.
In case of a mobile UE moving in opposite direction to the satellite movement, the same steps listed above in respect of the UE 50 breaking the order of PSCell changes or failing to connect to a target cell are also applicable here.

105. The source node (NTN node) 20 that triggered the HO to the target node (TN node) 32, receives HO Request Ack that includes the CPA and CPC configurations prepared by the target SN(s) 30 (as outlined above) in the HO Request Ack (for a legacy HO).

106. In case of a CHO, the HO Request Ack includes the CHO configuration together with CPA and CPC configurations, which is reconfigured by the source node 20 at the UE together with CHO and CPA/CPC execution conditions for each PCell/PSCell.

107. On receiving the HO command, UE may autonomously apply the CPA/CPC configurations together with execution conditions (115). The HO command includes information including the CPA (addition) configuration for the first target cell and the CPC (delta) configurations for the subsequent target cells.

108. UE 50 applies the addition configuration to connect to target secondary node 30.
The execution condition for changing target cells may be a time window as in NTN CHO or the decision may be made jointly with radio measurements performed within the configured time window.
In case of CHO, the UE 50 may monitor the configured CHO execution condition.
followed by CPA and subsequently CPC conditions.

109. The status of the secondary node is transferred from the serving node 20 to the TN 32.

110. UE 50 connects to cell 1 of TN 32 using random access procedure

111. RRC reconfiguration complete message transmitted by UE 50.

112. TN 32 transmits SN reconfiguration complete message to target SN 30.

113. UE connects to cell 1 of target SN 30 using random access procedure.

114. Path switch occurs.

116. UE connects to cell 2 of target SN 30 using random access procedure.

FIG. 4A schematically shows how LEO satellite 40 may contain a NTN network node 30, that provides radio coverage via cells 1, 2. NTN network node 30 comprises transmitting and receiving circuitry 32 and circuitry 34 that may be a processor (see FIG. 4B) for receiving and generating messages. These cells 1, 2 may provide overlapping coverage with cell 21 provided by a terrestrial node or gNB 20. Node gNB comprises circuitry that may be a processor 23 for generating messages and transmitting and receiving circuitry 24. User equipment 50 that is configured for dual connectivity and is located within cell 21 may have cell 21 as a primary serving cell and may be connected to cell 1 as a secondary cell. As satellite 40 moves, then if the UE is stationary movement of the satellite causes the radio coverage of cell 1 provided by NTN node 30 to move beyond the UE and radio coverage of cell 2 to start to provide coverage for the UE 50.

When the UE 50 connected to the secondary node 40 with a secondary node addition request for example, the UE 50 may have been provided with configuration information for both cell 1 and cell 2. The configuration information for cell 2 may have been a delta configuration indicating a change in configuration from cell 1. The UE 50 may have stored this information in data store 52 (see FIG. 4B). The information may have been received in conjunction with conditions indicating when the cell might become valid and this may also be stored, in some cases along with a cell ID, so that the UE may check it is the expected cell. When circuitry 53 within the UE 50 which circuitry may be a processor, determines that the condition related to cell 2, which may be a time, is fulfilled then it determines that cell 2 may now provide radio coverage to the UE 50. Circuitry 53 may respond to this by controlling the UE 50 to perform L3 measurements to determine if the coverage from cell 2 is above a threshold or better than the radio coverage from cell 1 and where so it might apply the configuration for cell 2 and perform a random access procedure for cell 2.

Summary of Key Methods provided by embodiments:
Conditional preparation of CPAC conditional PSCell addition and change configurations by a target node to enable dual connectivity.
Preparation of target cells by the source node for conditional mobility based on the mobility pattern where the prepared configurations uses the previous configuration as reference for delta configuration rather than the source configuration. Method is applicable for CHO conditional handover and CPAC.
gNB transmission of modified RRC Reconfiguration message for conditional reconfiguration including the mobility pattern and/or validity information of configuration which determines the applicability of the target configuration.
Inclusion of conditional configuration for target cell which can be applied if the mobility-pattern is not satisfied for the target cell.

Some embodiments may provide one or more of the following advantages:
Enables the activation of Dual connectivity between NTN-TN with minimal or at least reduced assistance information.
Enables conditional mobility based on the mobility pattern by preparing multiple CHO and/or CPAC configurations in advance with delta configuration.
Network need not have to configure the UE for each SN change; thus, saving the signalling between the network elements.
UE may autonomously apply the CPAC configuration with or without radio measurements.

Embodiments are related to 5G NR NTN, UE and gNB. Embodiments propose a configuration mechanism for dual connectivity between TN and NTN, specifically for the Conditional PSCell (primary secondary cell) Change or addition. The UE (served by a TN cell) can perform subsequent CPC (conditional PSCell change) based on measurement and/or visibility of satellites where sequent CPC configuration will be configured to UE. This allows the UE to be configured for multiple CPC during a time range in one signal. It avoids or at least reduces unnecessary measurements by the UE to find PSCell: UE only measures the target cell when it is supposed to be visible, if the UE knows the time window of the visibility of satellites, it may omit the measurement of some target cells, knowing they would not be visible leading to a reduced signalling overhead.

Embodiments are applied to NTN coverage provided by LEO with overlapping TN coverage (the overlapping coverage may be continuous or discontinuous). UE may perform initial access either to the NTN or to the TN. In one scenario (illustrated in FIG. 1) the UE is served by TN cell, if the source node (TN node) decides to configure dual connectivity with the LEO NTN cell as PSCell, due to LEO satellite movement, the PSCell serving the UE changes; given that the changing PSCell (due to satellite movement) may belong to the same Secondary Node (SN) or a different SN, the source node needs to (re)configure the UE periodically based on the PSCell switching time (due to satellite movement), which results in quite a lot of extra signalling. This has identified NTN specific new enhancements to enable Conditional PSCell Change (CPC) in this scenario efficiently.

In the scenario outlined in FIG. 3 (UE is served by NTN cell), on detection of TN coverage, UE may likely be handed over to TN cell and the TN node may configure the dual connectivity (DC) during overlapping coverage based on throughput requirements. In this scenario for the TN to configure DC and subsequent Conditional PSCell Change (CPC) with NTN LEO (that has a predictable cell or beam switching time due to LEO satellite movement), to prepare the Conditional PSCell change (CPC) configuration based on this predicted movement.

Embodiments enable the activation of Dual connectivity between NTN-TN with minimal or reduced assistance information. Embodiments enable conditional mobility based on the mobility pattern by preparing multiple CHO and/or CPAC configurations in advance with delta configuration. The network need not have to configure the UE for each SN change; thus, saving the signalling between the network elements and UE may autonomously apply the CPAC configuration with or without radio measurements. Conditional preparation of CPAC configurations by the target node to enable dual connectivity. Preparation of target cells by the source node for conditional mobility based on the mobility pattern where the prepared configurations uses the previous configuration as reference for delta configuration rather than the source configuration.

Embodiments provide methods that are applicable for CHO and CPAC. gNB transmission of modified RRC Reconfiguration message for conditional reconfiguration includes the mobility pattern or validity information of configuration which determines the applicability of the target configuration. Inclusion of conditional configuration for target cell which can be applied if the mobility-pattern is not satisfied for the target cell.

In embodiments, based on the L3 UE measurements configured to detect NTN cell coverage, the source node (TN node) initiates the PSCell addition procedure (SN Addition Request) to the target secondary node (target SN NTN node). In response to the SN Addition procedure, the target SN includes satellite related assistance information and associated configuration for PSCell addition. The assistance information is used by the source node (TN node) to prepare subsequent PSCell changes. Assistance information might be for example an NTN cell or NTN satellite beam switching time etc. Using the assistance information, the source node (TN node) prepares the target SN(s)(NTN node(s)) for subsequent PSCell changes. As part of this step, the source node in the SN Addition Request may include a flag ‘subsequent CPC’ along with the Initial PSCell Addition configuration to be used as a base configuration by the target SN (NTN target node) to prepare delta configuration for subsequent PSCell changes. For example, the target node prepares the Conditional PSCell Change (CPC) configurations for subsequent PSCell changes using the CPC configuration of previous PSCell as the base. i.e. the first PSCell change (or simply first CPC) configuration shall be the delta configuration with initial PSCell Addition (CPA) full configuration as the base. And subsequent CPC configurations shall be the delta configuration of the previous CPC configuration. The source node reconfigures the UE with the Conditional PSCell Addition (CPA) configuration (which is the full base configuration) and CPC configurations for the subsequent PSCell changes together with CPC execution condition for each PSCell event. The CPC configuration can be delta configuration which can be applied by the UE consecutively after each PSCell change without creating any reconfiguration failure (the configuration of the new PSCell is a delta configuration with respect the previous serving PSCell configuration). The CPC execution condition may include the validity info of the CPC configuration. For example, if a mobile UE moves in a direction opposite to the satellite movement, then the UE may likely break the order of PSCell change due to satellite movement, thus may apply a wrong CPC configuration. In order to handle this, the CPC execution condition may include validity info e.g. CPC config mapped to the PCI of the PSCell. UE applies the configuration based on the PSCell it is accessing. In case the UE breaks the order of PSCell changes, then it may: either construct a configuration with reference to the last applied configuration and the delta configuration of the skipped PSCells, or simply indicate to the network of the skip in the order of PSCell change; thus, allowing the network to reconfigure the UE.

In one embodiment, a UE may autonomously apply the received configuration based on the predicted information of the PSCell or NTN satellite beam switch (e.g. time window) or any other configured CPC triggers. Source gNB may indicate the list of target cells to be prepared for consecutive CHO and the predefined pattern of mobility to Target gNB. Target gNB prepares multiple target cells based on the delta configuration of each previous cell and includes the same in HO Request Ack message. In cases where the list contains target cells that belong to different gNB s, the source gNB completes the HO preparation in sequence based on the last prepared target cell as reference for next preparation. The CHO configuration towards UE may include a new parameter ‘mobility pattern’ where the given configurations are applicable. This new parameter indicates the expected sequence of CHO execution applicable for given configuration.

Source Node may provide additional conditional configuration for target cell which does not depend on the pattern, if required based on UE measurement report. This new configuration is maintained as additional entry in the conditional configuration list. When CHO condition is met for the target cell, based on whether it matches the pattern or not, UE may select configuration prepared for successive CHO or the normal CHO configuration.

On detection of TN coverage, a UE served by the NTN cell may be configured to trigger HO to the TN cell based on L3 measurements. Given the NTN node is triggering the HO to the TN cell, the NTN node may include assistance information (e.g. NTN cell or satellite beam switching time from ephemeris) in the HO request to enable the TN node to configure dual connectivity (DC) with NTN as secondary node (SN). The target node (TN node), based on the assistance information in HO Request and the UE L3 measurements, may decide to configure conditional PSCell Addition (CPA) by preparing target node (NTN node). In the SN addition procedure, the target node (TN node) may include assistance information e.g. a flag— ‘subsequent CPC’ to indicate to the target SN (NTN node) to prepare subsequent CPC configuration for the consecutive PSCells supported by the target SN. As in the solution of FIG. 1 captured above, the target SN prepares the consecutive CPC configuration with initial CPA configuration as full base configuration and the subsequent CPC configuration (for consecutive PSCell changes) as the delta configuration to the previous PSCell configuration. The initial PSCell addition shall be a full base configuration, upon which the CPC configuration for the subsequent PSCells is prepared as delta of the previous PSCell configuration. In case of a mobile UE moving in opposite direction to the satellite movement, the steps listed in the sub bullets of step 6 in FIG. 1 are also applicable here. The source node (NTN node) that triggered the HO to the target node (TN node), receives HO Request Ack that includes the CPA and CPC configurations prepared by the target SN(s) (as outlined above) in the HO Request Ack (for a legacy HO). In case of a CHO, the HO Request Ack includes the CHO configuration together with CPA and CPC configurations, which is reconfigured by the source node at the UE together with CHO and CPA/CPC execution conditions for each PCell/PSCell. On receiving the HO command, UE may autonomously apply the CPA/CPC configurations together with execution conditions. The execution condition may be a time window as in NTN CHO or jointly with radio measurements performed within configured time window. In case of CHO, the UE may monitor the configured CHO execution condition: followed by CPA and subsequently CPC conditions.

In this disclosure:
CHO Conditional Handover
CPA Conditional PSCell Addition
CPC Conditional PSCell Change
CPAC Conditional PSCell Addition and Change
GEO Geosynchronous Earth Orbit
MEO Medium Earth Orbit
LEO Low Earth Orbit
NTN Non Terrestrial Network
PCI Physical Cell Identity
SN Secondary Node
TN Terrestrial Network
UE User Equipment
PSCell primary secondary cell or primary cell with secondary node resource

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The term non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus for accessing a radio access network, said radio access network comprising a plurality of network nodes each supporting providing radio coverage via at least one cell, said apparatus comprising:
at least one processor; and
at least one memory storing instructions that, when executed by the at least one processor, cause the apparatus at least to:
respond to receipt of a message received from a serving network node, said message comprising information indicative of a plurality of configurations for a plurality of target cells and a request indicating an order in which said apparatus is predicted to access said target cells, said information comprising information indicative of at least one full configuration for a first cell in said predicted order and at least one delta configuration indicating a change in configuration compared to a configuration for a previous cell, by:
storing said information.

2. An apparatus according to claim 1, wherein said information further comprises a plurality of conditions corresponding to said plurality of target cells; said apparatus being further configured to
determine when one of said plurality of conditions becomes fulfilled for said apparatus.

3. An apparatus according to claim 2, said apparatus being configured on determining said one of said plurality of conditions is fulfilled, to apply a corresponding one of said configurations.

4. An apparatus according to claim 2, wherein said message further comprises validity information related to at least one of the plurality of configurations, said apparatus being configured to verify using said validity information, when one of said plurality of conditions becomes fulfilled for said apparatus whether a corresponding target cell corresponds to a cell that said apparatus is seeking to access and where not, to not apply said corresponding configuration.

5. An apparatus according to claim 3, wherein prior to applying said corresponding one of said configurations, said apparatus is configured to perform measurements to determine whether to connect to said corresponding target cell.

6. An apparatus according to claim 2, wherein one of said plurality of conditions become fulfilled when it is predicted that the apparatus is within the radio coverage of the corresponding cell.

7. An apparatus according to claim 6, wherein said one of said plurality of conditions comprises a validity time, said validity time being a time when it is predicted that said apparatus is within the radio coverage of the corresponding cell.

8. An apparatus according to claim 1, wherein said information indicative of said plurality of configurations for said plurality of target cells comprises a configuration for a plurality of subsequent cells each comprising a delta configuration indicating a change in configuration compared to a configuration for a previous cell in said predicted order.

9. An apparatus according to claim 1, wherein, said apparatus is configured in response to missing at least one target cell of said plurality of target cells in said predicted order by not accessing said at least one target cell, to construct an updated delta configuration for a cell subsequent to said at least one missed cell using a delta configuration of said at least one missed target cell, said updated delta configuration indicating a change in configuration compared to a most recently accessed cell.

10. An apparatus according to claim 1, wherein, said apparatus is configured in response to missing at least one target cell of said plurality of target cells in said predicted order by not accessing said at least one target cell, said apparatus is configured to request that said radio access network reconfigures said apparatus.

11. An apparatus according to claim 1, wherein said apparatus is configured for dual connectivity and said plurality of target cells comprise secondary cells provided by at least one non-terrestrial network (NTN) node.

12. An apparatus according to claim 11, wherein said at least one NTN node comprises at least two NTN nodes.

13. An apparatus according to claim 1, wherein said serving network node comprises a terrestrial network (TN) node and comprises a master node providing a primary serving cell.

14. An apparatus according to claim 1, wherein said serving network node comprises a NTN node and comprises a master node providing a primary serving cell.

15. An apparatus according to claim 1, wherein said apparatus is configured for single connectivity and said plurality of target cells are provided by at least one of the following: at least one TN node, at least one NTN node.

16. An apparatus according to claim 1, wherein said apparatus comprises a UE.

17. An apparatus for supporting providing radio coverage via a plurality of cells, said apparatus comprising:
at least one processor; and
at least one memory storing instructions that, when executed by the at least one processor, cause the apparatus at least to:
respond to receipt of a request for providing access for a user equipment to at least some of said plurality of cells, said at least some of said plurality of cells comprising target cells for said user equipment and said request indicating an order in which said user equipment is predicted to access said target cells by:
generating a message comprising information indicative of a plurality of configurations for said target cells, said information comprising information indicative of at least one delta configuration indicating a change in configuration of one cell compared to a configuration for a previous cell in said predicted order.

18. An apparatus according to claim 17, wherein said information indicative of a plurality of configurations for said target cells comprises a full configuration for a first cell being visited and a delta configuration for subsequent cells, said delta configuration comprising a change in configuration compared to a previous cell in said order.

19. An apparatus according to claim 17, wherein said request comprises a full configuration for an initial target cell, and said information indicative of configuration for said plurality of cells comprises a plurality of delta configurations for a plurality of subsequent target cells, said delta configurations comprising a change in configuration compared to a previous cell in said order, a first delta configuration comprising a change in configuration compared to sad initial target cell.

20. An apparatus for supporting providing radio coverage via at least one cell, said apparatus comprising:
at least one processor; and
at least one memory storing instructions that, when executed by the at least one processor, cause the apparatus at least to:
generate a message for transmission to a user equipment connected to said at least one cell, said message comprising information indicative of a plurality of configurations for a plurality of target cells for said user equipment and an order in which said user equipment is predicted to access said target cells, said information comprising information indicative of a full configuration for a first cell and at least one delta configuration indicating a change in configuration compared to a configuration for a previous cell in said order.
